(19) United States
(12) Patent Application Publication
(10) Pub. No.: US 2020/0201886 A1
(43) Pub. Date: Jun. 25, 2020

(54) SYSTEMS AND METHODS FOR CLUSTER EXPLORATION IN A CONFIGURATION MANAGEMENT DATABASE (CMDB) PLATFORM

(71) Applicant: ServiceNow, Inc., Santa Clara, CA (US)

(72) Inventors: Tom Bar Oz, Tel Aviv (IL); Shiri Hameiri, Tel Aviv (IL); Boris Erblat, Tel Aviv (IL); Bary Solomon, Tel Aviv (IL)

(21) Appl. No.: 16/261,177

(22) Filed: Jan. 29, 2019

Related U.S. Application Data
(60) Provisional application No. 62/782,098, filed on Dec. 19, 2018.

(51) Int. Cl. G06F 16/28; G06F 9/50; H04L 29/12

(52) U.S. Cl. CPC G06F 16/284; H04L 29/12009; G06F 9/50

(57) ABSTRACT

The present disclosure relates generally to configuration management databases (CMDBs) and clusters, and more specifically, to enabling exploration of high-availability (HA) clusters within a CMDB platform. A CMDB system is disclosed that includes at least one processor configured to execute instructions stored in the memory to perform actions including: retrieving cluster information regarding a HA cluster; storing the cluster information as configuration items (CIs) within a CMDB; and in response to receiving a request for the cluster information, retrieving the cluster information from the CIs of the CMDB and providing the cluster information as a response to the request.

### CROSS-REFERENCE TO RELATED APPLICATIONS

This application claims priority from and the benefit of U.S. Provisional Application Ser. No. 62/782,098, entitled “SYSTEMS AND METHODS FOR CLUSTER EXPLORATION IN A CONFIGURATION MANAGEMENT DATABASE (CMDB) PLATFORM”, filed Dec. 19, 2018, which is hereby incorporated by reference in its entirety for all purposes.

### BACKGROUND

The present disclosure relates generally to configuration management databases (CMDBs) and clusters, and more specifically, to enabling exploration of high-availability (HA) clusters within a CMDB platform.

This section is intended to introduce the reader to various aspects of art that may be related to various aspects of the present disclosure, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

Organizations, regardless of size, rely upon access to information technology (IT) and data and services for their continued operation and success. A respective organization's IT infrastructure may have associated hardware resources (e.g. computing devices, load balancers, firewalls, switches, etc.) and software resources (e.g. productivity software, database applications, custom applications, and so forth). Over time, more and more organizations have turned to cloud computing approaches to supplement or enhance their IT infrastructure solutions.

Cloud computing relates to the sharing of computing resources that are generally accessed via the Internet. In particular, a cloud computing infrastructure allows users, such as individuals and/or enterprises, to access a shared pool of computing resources, such as servers, storage devices, networks, applications, and/or other computing based services. By doing so, users are able to access computing resources on demand that are located at remote locations, which resources may be used to perform a variety of computing functions (e.g., storing and/or processing large quantities of computing data). For enterprise and other organization users, cloud computing provides flexibility in accessing cloud computing resources without accruing large up-front costs, such as purchasing expensive network equipment or investing large amounts of time in establishing a private network infrastructure. Instead, by utilizing cloud computing resources, users are able redirect their resources to focus on their enterprise's core functions.

Within such a platform, high-availability (HA) clusters enable an application to be executed by different nodes of the cluster in the event of a failure or error, which can significantly improve application availability. As such, HA clusters are contrasted from high-performance (HP) clusters, which can enable improved application performance by simultaneously executing the application across multiple nodes of the cluster. By using multiple hardware resources (e.g., network cards, processors, memory, storage area networks), HA clusters improve the availability of an application by effectively eliminating single points of failure. HA clusters can be used to host and execute a number of different types of applications, such as, for example, databases, network file sharing application, and web servers.

### SUMMARY

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

Recognizing that the topology and status of a high-availability (HA) cluster can be complex and difficult to readily determine or visualize, present embodiments are directed to systems and methods that enable cluster information to be determined and then subsequently stored and accessed as configuration items (CIs) of a CMDB. For example, cluster information may include server/hardware information, cluster status information, cluster node information, cluster resource/resource group information, and virtual internet protocol (VIP) address information. In certain embodiments, the disclosed system may determine cluster information by performing function calls associated with a HA cluster server that hosts the HA cluster, by reading configuration files associated with the HA cluster server, or a combination thereof. Additionally, present embodiments include a database table design that enables this cluster information to be stored as CIs that are related to other CIs of the CMDB. Furthermore, present embodiments include a graphical user interface (GUI) that enables this cluster information to be presented and explored in an efficient manner.

Various refinements of the features noted above may exist in relation to various aspects of the present disclosure. Further features may also be incorporated in these various aspects as well. These refinements and additional features may exist individually or in any combination. For instance, various features discussed below in relation to one or more of the illustrated embodiments may be incorporated into any of the above-described aspects of the present disclosure alone or in any combination. The brief summary presented above is intended only to familiarize the reader with certain aspects and contexts of embodiments of the present disclosure without limitation to the claimed subject matter.

### BRIEF DESCRIPTION OF THE DRAWINGS

Various aspects of this disclosure may be better understood upon reading the following detailed description and upon reference to the drawings in which:

FIG. 1 is a block diagram of an embodiment of a cloud architecture in which embodiments of the present disclosure may operate;

FIG. 2 is a schematic diagram of an embodiment of a multi-instance cloud architecture in which embodiments of the present disclosure may operate;

FIG. 3 is a block diagram of a computing device utilized in a computing system that may be present in FIG. 1 or 2, in accordance with aspects of the present disclosure;

FIG. 4 is a block diagram illustrating an embodiment in which a virtual server supports and enables the client instance, in accordance with aspects of the present disclosure;

FIG. 5 is a model diagram illustrating database tables for an embodiment of a cluster database of a configuration management database (CMDB), in accordance with aspects of the present disclosure;

FIG. 6 is a portion of a graphical user interface (GUI) including a diagram illustrating configuration items (CIs) populated for an example high-availability (HA) cluster, in accordance with aspects of the present disclosure;

FIG. 7 is a simulated screenshot of a portion of the GUI presenting information for the example HA cluster, in accordance with aspects of the present disclosure;

FIG. 8 is a simulated screenshot of another portion of the GUI presenting cluster resource information for the example HA cluster, in accordance with aspects of the present disclosure;

FIG. 9 is a simulated screenshot of another portion of the GUI presenting cluster node information for the example HA cluster, in accordance with aspects of the present disclosure;

FIG. 10 is a simulated screenshot of another portion of the GUI presenting cluster virtual internet protocol (VIP) address information for the example HA cluster, in accordance with aspects of the present disclosure; and

FIG. 11 is a simulated screenshot of another portion of the GUI presenting cluster resource group information for the example HA cluster, in accordance with aspects of the present disclosure.

### DETAILED DESCRIPTION

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and enterprise-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

As used herein, the term “computing system” refers to an electronic computing device such as, but not limited to, a single computer, virtual machine, virtual container, host, server, laptop, and/or mobile device, or to a plurality of electronic computing devices working together to perform the function described as being performed on or by the computing system. As used herein, the term “medium” refers to one or more non-transitory, computer-readable physical media that together store the contents described as being stored thereon. Embodiments may include non-volatile secondary storage, read-only memory (ROM), and/or random-access memory (RAM). As used herein, the term “application” refers to one or more computing modules, programs, processes, workloads, threads and/or a set of computing instructions executed by a computing system. Example embodiments of an application include software modules, software objects, software instances and/or other types of executable code. As used herein, the term “configuration item” or “CI” refers to a record for any component (e.g., computer, device, piece of software, database table, script, webpage, piece of metadata, and so forth) in an enterprise network, for which relevant data, such as manufacturer, vendor, location, or similar data, is stored in a configuration management database (CMDB).

As mentioned, high-availability (HA) clusters can improve application availability by enabling an application to be executed by different nodes of the cluster in the event of a failure or error. However, the topology and status of a HA cluster can be complex and difficult to readily determine or visualize. As such, present embodiments are directed to systems and methods that enable cluster information (e.g., cluster status information, resource/resource group information, node information, virtual internet protocol (VIP) address information) to be determined and then stored and accessed as configuration items (CIs) within a CMDB. Additionally, present embodiments include a graphical user interface (GUI) that enables this cluster information to be presented and explored in an efficient manner.

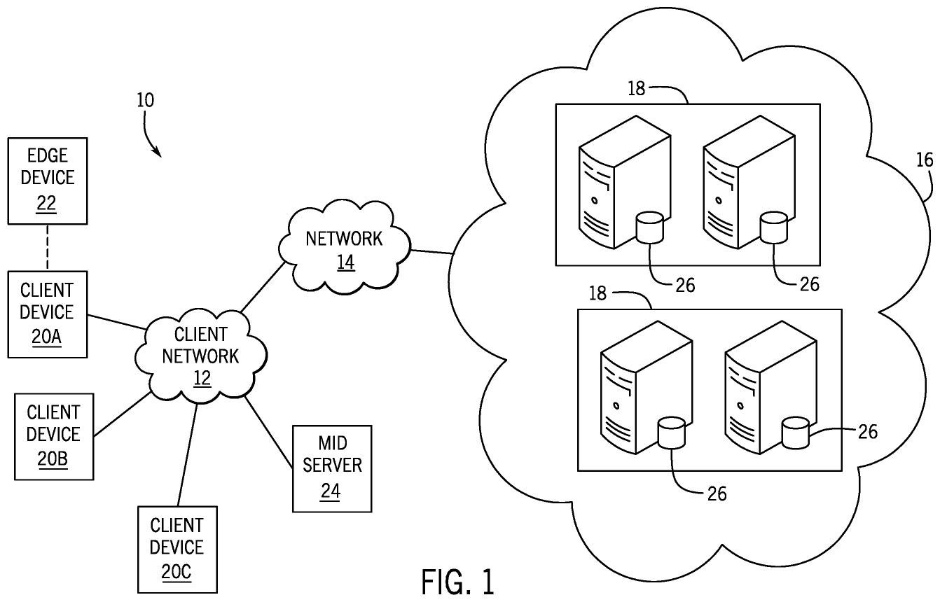

With the preceding in mind, the following figures relate to various types of generalized system architectures or configurations that may be employed to provide services to an organization in a multi-instance framework and on which the present approaches may be employed. Correspondingly, these system and platform examples may also relate to systems and platforms on which the techniques discussed herein may be implemented or otherwise utilized. Turning now to FIG. 1, a schematic diagram of an embodiment of a cloud computing system 10 where embodiments of the present disclosure may operate, is illustrated. The cloud computing system 10 may include a client network 12, a network 14 (e.g., the Internet), and a cloud-based platform 16. In some implementations, the cloud-based platform 16 may be a configuration management database (CMDB) platform. In one embodiment, the client network 12 may be a local private network, such as local area network (LAN) having a variety of network devices that include, but are not limited to, switches, servers, and routers. In another embodiment, the client network 12 represents an enterprise network that could include one or more LANs, virtual networks, data centers 18, and/or other remote networks. As shown in FIG. 1, the client network 12 is able to connect to one or more client devices 20A, 20B, and 20C so that the client devices are able to communicate with each other and/or with the network hosting the platform 16. The client devices 20 may be computing systems and/or other types of computing devices generally referred to as Internet of Things (IoT) devices that access cloud computing services, for example, via a web browser application or via an edge device 22 that may act as a gateway between the client devices 20 and the platform 16. FIG. 1 also illustrates that the client network 12 includes an administration or managerial device or server, such as a management, instrumentation, and discovery (MID) server 24 that facilitates communication of data between the network hosting the platform 16, other external applications, data sources, and services, and the client network 12. Although not specifically illustrated in FIG. 1, the client network 12 may also include a connecting network device (e.g., a gateway or router) or a combination of devices that implement a customer firewall or intrusion protection system.

For the illustrated embodiment, FIG. 1 illustrates that client network 12 is coupled to a network 14. The network 14 may include one or more computing networks, such as other LANs, wide area networks (WAN), the Internet, and/or other remote networks, to transfer data between the client devices 20 and the network hosting the platform 16. Each of the computing networks within network 14 may contain wired and/or wireless programmable devices that operate in the electrical and/or optical domain. For example, network 14 may include wireless networks, such as cellular networks (e.g., Global System for Mobile Communications (GSM) based cellular network), IEEE 802.11 networks, and/or other suitable radio-based networks. The network 14 may also employ any number of network communication protocols, such as Transmission Control Protocol (TCP) and Internet Protocol (IP). Although not explicitly shown in FIG. 1, network 14 may include a variety of network devices, such as servers, routers, network switches, and/or other network hardware devices configured to transport data over the network 14.

In FIG. 1, the network hosting the platform 16 may be a remote network (e.g., a cloud network) that is able to communicate with the client devices 20 via the client network 12 and network 14. The network hosting the platform 16 provides additional computing resources to the client devices 20 and/or the client network 12. For example, by utilizing the network hosting the platform 16, users of the client devices 20 are able to build and execute applications for various enterprise, IT, and/or other organization-related functions. In one embodiment, the network hosting the platform 16 is implemented on the one or more data centers 18, where each data center could correspond to a different geographic location. Each of the data centers 18 includes a plurality of virtual servers 26 (also referred to herein as application nodes, application servers, virtual server instances, application instances, or application server instances), where each virtual server 26 can be implemented on a physical computing system, such as a single electronic computing device (e.g., a single physical hardware server) or across multiple-computing devices (e.g., multiple physical hardware servers). Examples of virtual servers 26 include, but are not limited to a web server (e.g., a unitary Apache installation), an application server (e.g., unitary JAVA Virtual Machine), and/or a database server (e.g., a unitary relational database management system (RDBMS) catalog).

To utilize computing resources within the platform 16, network operators may choose to configure the data centers 18 using a variety of computing infrastructures. In one embodiment, one or more of the data centers 18 are configured using a multi-tenant cloud architecture, such that one of the server instances 26 handles requests from and serves multiple customers. Data centers 18 with multi-tenant cloud architecture commingle and store data from multiple customers, where multiple customer instances are assigned to one of the virtual servers 26. In a multi-tenant cloud architecture, the particular virtual server 26 distinguishes between and segregates data and other information of the various customers. For example, a multi-tenant cloud architecture could assign a particular identifier for each customer in order to identify and segregate the data from each customer. Generally, implementing a multi-tenant cloud architecture may suffer from various drawbacks, such as a failure of a particular one of the server instances 26 causing outages for all customers allocated to the particular server instance.

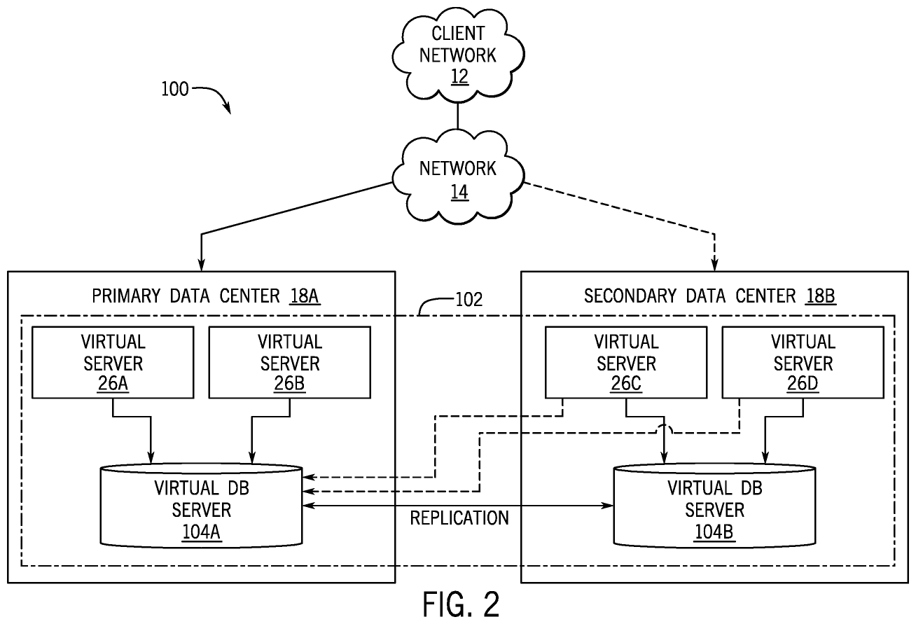

In another embodiment, one or more of the data centers 18 are configured using a multi-instance cloud architecture to provide every customer its own unique customer instance or instances. For example, a multi-instance cloud architecture could provide each customer instance with its own dedicated application server and dedicated database server. In other examples, the multi-instance cloud architecture could deploy a single physical or virtual server 26 and/or other combinations of physical and/or virtual servers 26, such as one or more dedicated web servers, one or more dedicated application servers, and one or more database servers, for each customer instance. In a multi-instance cloud architecture, multiple customer instances could be installed on one or more respective hardware servers, where each customer instance is allocated certain portions of the physical server resources, such as computing memory, storage, and processing power. By doing so, each customer instance has its own unique software stack that provides the benefit of data isolation, relatively less downtime for customers to access the platform 16, and customer-driven upgrade schedules. An example of implementing a customer instance within a multi-instance cloud architecture will be discussed in more detail below with reference to FIG. 2.

FIG. 2 is a schematic diagram of an embodiment of a multi-instance cloud architecture 100 where embodiments of the present disclosure may operate. FIG. 2 illustrates that the multi-instance cloud architecture 100 includes the client network 12 and the network 14 that connect to two (e.g., paired) data centers 18A and 18B that may be geographically separated from one another. Using FIG. 2 as an example, network environment and service provider cloud infrastructure client instance 102 (also referred to herein as a client instance 102) is associated with (e.g., supported and enabled by) dedicated virtual servers (e.g., virtual servers 26A, 26B, 26C, and 26D) and dedicated database servers (e.g., virtual database servers 104A and 104B). Stated another way, the virtual servers 26A-26D and virtual database servers 104A and 104B are not shared with other client instances and are specific to the respective client instance 102. In the depicted example, to facilitate availability of the client instance 102, the virtual servers 26A-26D and virtual database servers 104A and 104B are allocated to two different data centers 18A and 18B so that one of the data centers 18 acts as a backup data center. Other embodiments of the multi-instance cloud architecture 100 could include other types of dedicated virtual servers, such as a web server. For example, the client instance 102 could be associated with (e.g., supported and enabled by) the dedicated virtual servers 26A-26D, dedicated virtual database servers 104A and 104B, and additional dedicated virtual web servers (not shown in FIG. 2).

Although FIGS. 1 and 2 illustrate specific embodiments of a cloud computing system 10 and a multi-instance cloud architecture 100, respectively, the disclosure is not limited to the specific embodiments illustrated in FIGS. 1 and 2. For instance, although FIG. 1 illustrates that the platform 16 is implemented using data centers, other embodiments of the platform 16 are not limited to data centers and can utilize other types of remote network infrastructures. Moreover, other embodiments of the present disclosure may combine one or more different virtual servers into a single virtual server or, conversely, perform operations attributed to a single virtual server using multiple virtual servers. For instance, using FIG. 2 as an example, the virtual servers 26A, 26B, 26C, 26D and virtual database servers 104A, 104B may be combined into a single virtual server. Moreover, the present approaches may be implemented in other architectures or configurations, including, but not limited to, multi-tenant architectures, generalized client/server implementations, and/or even on a single physical processor-based device configured to perform some or all of the operations discussed herein. Similarly, though virtual servers or machines may be referenced to facilitate discussion of an implementation, physical servers may instead be employed as appropriate. The use and discussion of FIGS. 1 and 2 are only examples to facilitate ease of description and explanation and are not intended to limit the disclosure to the specific examples illustrated therein.

As may be appreciated, the respective architectures and frameworks discussed with respect to FIGS. 1 and 2 incorporate computing systems of various types (e.g., servers, workstations, client devices, laptops, tablet computers, cellular telephones, and so forth) throughout. For the sake of completeness, a brief, high level overview of components typically found in such systems is provided. As may be appreciated, the present overview is intended to merely provide a high-level, generalized view of components typical in such computing systems and should not be viewed as limiting in terms of components discussed or omitted from discussion.

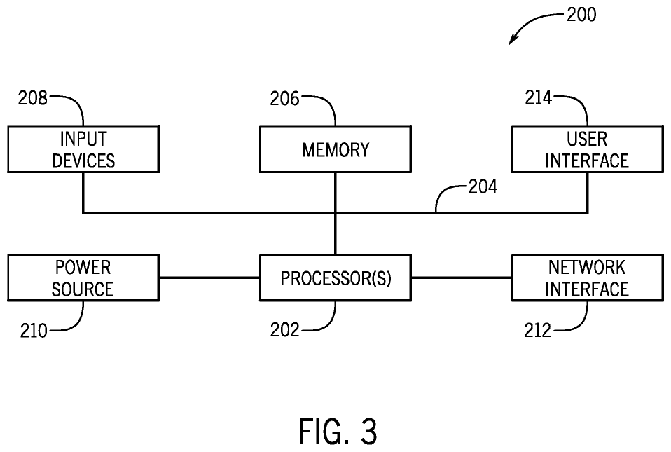

By way of background, it may be appreciated that the present approach may be implemented using one or more processor-based systems such as shown in FIG. 3. Likewise, applications and/or databases utilized in the present approach may be stored, employed, and/or maintained on such processor-based systems. As may be appreciated, such systems as shown in FIG. 3 may be present in a distributed computing environment, a networked environment, or other multi-computer platform or architecture. Likewise, systems such as that shown in FIG. 3, may be used in supporting or communicating with one or more virtual environments or computational instances on which the present approach may be implemented.

With this in mind, an example computer system may include some or all of the computer components depicted in FIG. 3. FIG. 3 generally illustrates a block diagram of example components of a computing system 200 and their potential interconnections or communication paths, such as along one or more busses. As illustrated, the computing system 200 may include various hardware components such as, but not limited to, one or more processors 202, one or more busses 204, memory 206, input devices 208, a power source 210, a network interface 212, a user interface 214, and/or other computer components useful in performing the functions described herein.

The one or more processors 202 may include one or more microprocessors capable of performing instructions stored in the memory 206. Additionally or alternatively, the one or more processors 202 may include application-specific integrated circuits (ASICs), field-programmable gate arrays (FPGAs), and/or other devices designed to perform some or all of the functions discussed herein without calling instructions from the memory 206.

With respect to other components, the one or more busses 204 include suitable electrical channels to provide data and/or power between the various components of the computing system 200. The memory 206 may include any tangible, non-transitory, and computer-readable storage media. Although shown as a single block in FIG. 1, the memory 206 can be implemented using multiple physical units of the same or different types in one or more physical locations. The input devices 208 correspond to structures to input data and/or commands to the one or more processors 202. For example, the input devices 208 may include a mouse, touchpad, touchscreen, keyboard and the like. The power source 210 can be any suitable source for power of the various components of the computing device 200, such as line power and/or a battery source. The network interface 212 includes one or more transceivers capable of communicating with other devices over one or more networks (e.g., a communication channel). The network interface 212 may provide a wired network interface or a wireless network interface. A user interface 214 may include a display that is configured to display text or images transferred to it from the one or more processors 202. In addition and/or alternative to the display, the user interface 214 may include other devices for interfacing with a user, such as lights (e.g., LEDs), speakers, and the like.

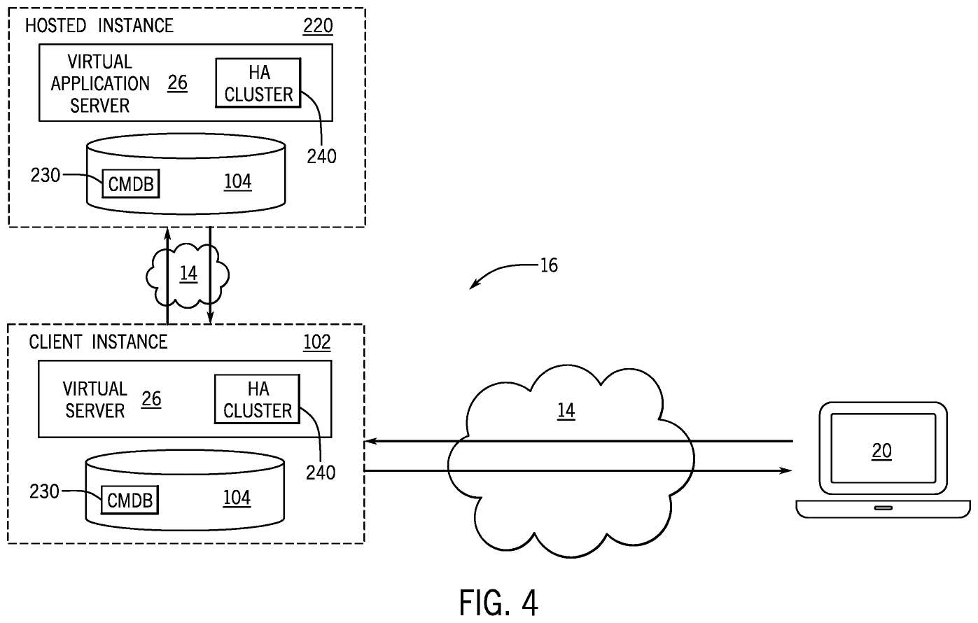

With the foregoing in mind, FIG. 4 is a block diagram illustrating an embodiment in which a virtual server 26 supports and enables the client instance 102, according to one or more disclosed embodiments. More specifically, FIG. 4 illustrates an example of a portion of a service provider cloud infrastructure, including the cloud-based platform 16 discussed above. The cloud-based platform 16 is connected to a client device 20 via the network 14 to provide a user interface to network applications executing within the client instance 102 (e.g., via a web browser of the client device 20). Client instance 102 is supported by virtual servers 26 similar to those explained with respect to FIG. 2, and is illustrated here to show support for the disclosed functionality described herein within the client instance 102. Cloud provider infrastructures are generally configured to support a plurality of end-user devices, such as client device 20, concurrently, wherein each end-user device is in communication with the single client instance 102. Also, cloud provider infrastructures may be configured to support any number of client instances, such as client instance 102, concurrently, with each of the instances in communication with one or more end-user devices. As mentioned above, an end-user may also interface with client instance 102 using an application that is executed within a web browser. The client instance 102 may also be configured to communicate with other instances, such as the hosted instance 220 shown in FIG. 4, which may also include a virtual application server 26 and a virtual database server 104.

As mentioned, in certain embodiments, the cloud-based platform 16 may be a CMDB platform. For such embodiments, as illustrated in FIG. 4, the database servers 104 of the CMDB platform include a CMDB 230 storing configuration item (CI) data associated with the client instance 102. Additionally, in certain embodiments, the virtual servers 26 may be or include a HA cluster server hosting one or more HA clusters 240. As mentioned, the HA cluster 240 is generally capable of moving application execution between different nodes in the event of a node is unable to perform or complete execution, which improves the availability of applications hosted by the virtual servers 26. As mentioned, present embodiments are directed to systems and methods that enable HA cluster information (e.g., status information, resource group information, resource information, node information, virtual IP information) to be determined and stored as CIs within the CMDB 230.

In certain embodiments, the HA cluster 240 may be implemented using VERITAS CLUSTER SERVER (VCS) (produced by Veritas Technologies, LLC of Santa Clara, Calif.; https://www.veritas.com) on a UNIX-based operating system (OS). For example, the present technique has been implemented on VCS version 6.1.10 on a SOLARIS operating system. Other examples UNIX-based operating systems include: UNIX, LINUX, and AIX. For such embodiments, various function calls and/or configuration files may be accessed by a script (e.g., a shell script) having sufficient privileges to determine the HA cluster information to be stored as CIs within the CMDB. For example, to verify that a Veritas Cluster High Availability Engine is running, the script may execute the following command: “ps -ef|grep had|grep -v grep”. To read a parameter (e.g., Address) from a VCS configuration file, the script may execute the following command: “cat /etcNRTSvcs/conf/config/main.cf|grep Address”. To retrieve a cluster universally unique identifier (UUID), the script may execute the following command: “/opt/VRTSvcs/bin/haclus -value ClusterUUID 2>/dev/null”. To retrieve a cluster name, the script may execute the following command: “/opt/VRTSvcs/bin/haclus -value ClusterName 2>/dev/null”. To retrieve a cluster version, the script may execute the following command: “/opt/VRTSvcs/bin/haclus -value EngineVersion”. To retrieve a cluster IP address, the script may execute the following command: “/opt/VRTSvcs/bin/haclus -value ClusterAddress”. To retrieve a cluster status, the script may execute the following command: “/opt/VRTSvcs/bin/haclus -value ClusState”. To retrieve the nodes of a cluster, the script may execute the following command: “/optNRTSvcs/bin/hasys -state”. To retrieve cluster resources, the script may execute the following command: “/optNRTSvcs/bin/hares -state”. To retrieve the type of the cluster resources, the script may execute the following command: “/opt/VRTSvcs/bin/hares -display|grep -w ‘Type’|grep ‘global’ 2>/dev/null”. To retrieve a resource group, the script may execute the following command: “/opt/VRTSvcs/bin/hares -display|grep Group 2>/dev/null”. To retrieve a resource group name and status, the script may execute the following command: “/optNRTSvcs/bin/hagrp -state 2>/dev/null”. It may be appreciated that, for embodiments that utilize a different HA cluster server or a non-UNIX-based OS, other suitable commands can be used to retrieve the HA cluster information, in accordance with the present disclosure. Additionally, the script that retrieves this HA cluster information may be executed periodically (e.g., every day, hour, or minute) or on-demand (e.g., in response to a request from a user, script, or process), in certain embodiments.

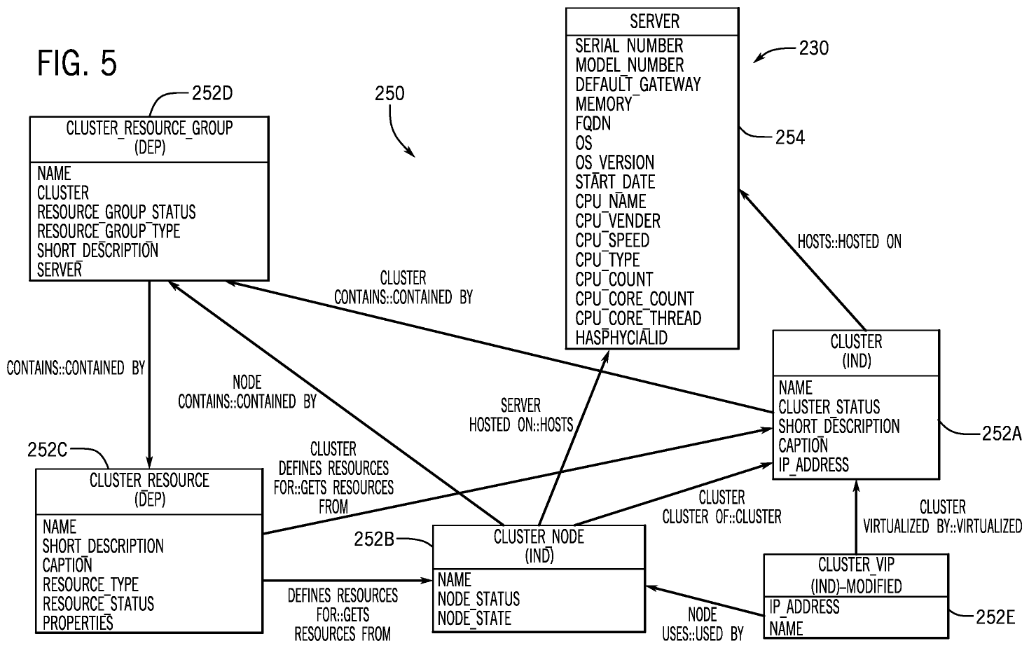

FIG. 5 is a model diagram illustrating database table structures for an example CMDB 230 that includes a cluster database 250 designed to store the retrieved HA cluster information as CI data within the CMDB 230, in accordance with an embodiment of the present approach. For the illustrated embodiment, the cluster database 250 includes a number of database tables 252 (e.g., tables 252A, 252B, 252C, 252D, and 252E), each designed to store particular information related to HA clusters. Additionally, as illustrated, database tables 252 are related to one another and related to other tables of the CMDB 230 via a number of one-to-many and many-to-one relationships. It may be appreciated that the CMDB 230, the cluster database 250, and the database tables 252 illustrated in FIG. 5 are merely provided as an example, and in other embodiments, the CMDB 230, the cluster database 250, and/or the database tables 252 may include other data structures, other fields, and/or other relationships, in accordance with the present disclosure. For the illustrated embodiment, the cluster node table 252B has a many-to-one relationship with the cluster table 252A; the cluster resource table 252C has a many-to-one relationship with the cluster table 252A, a many-to-one relationship with the cluster node table 252B, and a many-to-one relationship with the cluster resource group table 252D; the cluster resource group table 252D has a many-to-one relationship with the cluster table 252A, a many-to-one relationship with the cluster node table 252B, and a one-to-many relationship with the cluster resource table 252C; and the cluster VIP table 252E has a many-to-one relationship with the cluster table 252A and a many-to-one relationship with the cluster node table 252B.

For the illustrated example, the cluster table 252A of the cluster database 250 stores a cluster name, a cluster status, a description, a caption, and an IP address associated with each HA cluster. The cluster node table 252B of the cluster database 250 stores a node name, node status, and node state for nodes of the HA clusters of the cluster table 252A. The resource table 252C of the cluster database 250 stores a resource name, description, caption, resource type, resource status, and properties associated with resources of the HA clusters stored in the cluster table 252A and nodes stored in the cluster node table 252B. The cluster resource group table 252D of the cluster database 250 stores a resource group name, a cluster name of the resource, a resource group status, resource group type, description, and server associated with resource groups associated with the HA clusters stored in cluster table 252A and with nodes stored in cluster node table 252B. As such, it may be appreciated that the cluster resource group table 252D enables another HA cluster to be a resource group that provides resources to the associated HA cluster. Additionally, as illustrated, resources of the cluster resource table 252C can also be related to resource groups stored in the cluster resource group table 252D. The illustrated cluster VIP table 252E of the cluster database 250 stores the VIP name and a VIP address for nodes of the cluster node table 252B and HA clusters of the cluster table 252A.

Additionally, for the illustrated embodiment, the clusters of the cluster table 252A and the nodes of the cluster node table 252B are related to servers (e.g., hardware servers, physical servers), listed in server table 254 of the CMDB 230, that host the clusters and nodes. For example, the illustrated server table 254 includes a serial number, model number, default gateway IP address, memory information, fully qualified domain name, operating system (OS) and version information, start date, central processing unit (CPU) information, and a flag indicating whether the server has a physical identifier, for each server associated with the CMDB 230.

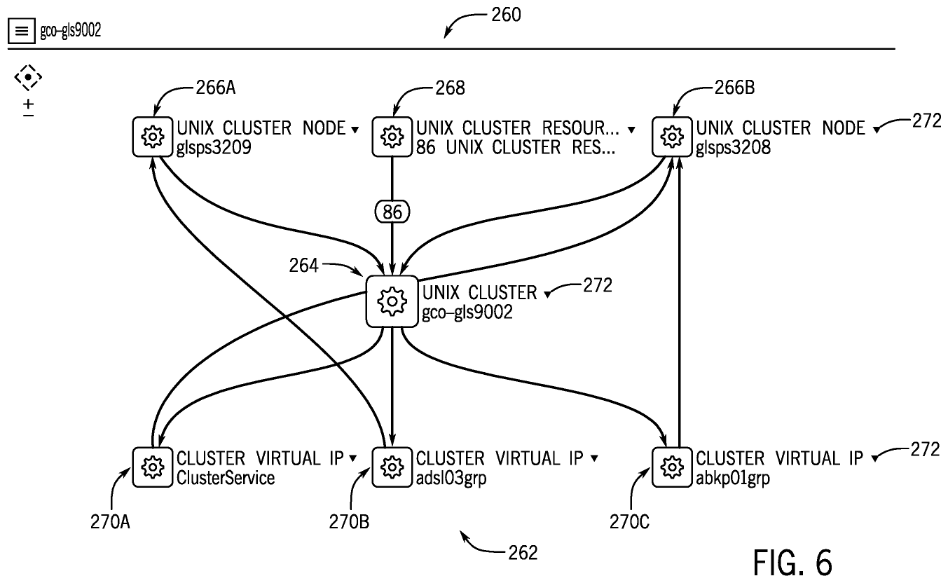

In addition to the cluster database 250, present embodiments include a graphical user interface (GUI) 260 that enables the cluster information stored in the cluster database 250 of the CMDB 230 to be presented and explored in an efficient manner. With this in mind, FIGS. 6-11 illustrate simulated screenshots of different portions of this GUI 260 designed to present the stored HA cluster information for an example embodiment of a HA cluster 240 having the cluster name, gco-gls9002. It may be appreciated that these screenshots are merely provided for one example GUI, and in other embodiments, the GUI 260 may include other portions, screens, fields, labels, buttons, tabs, and so forth, in accordance with the present disclosure.

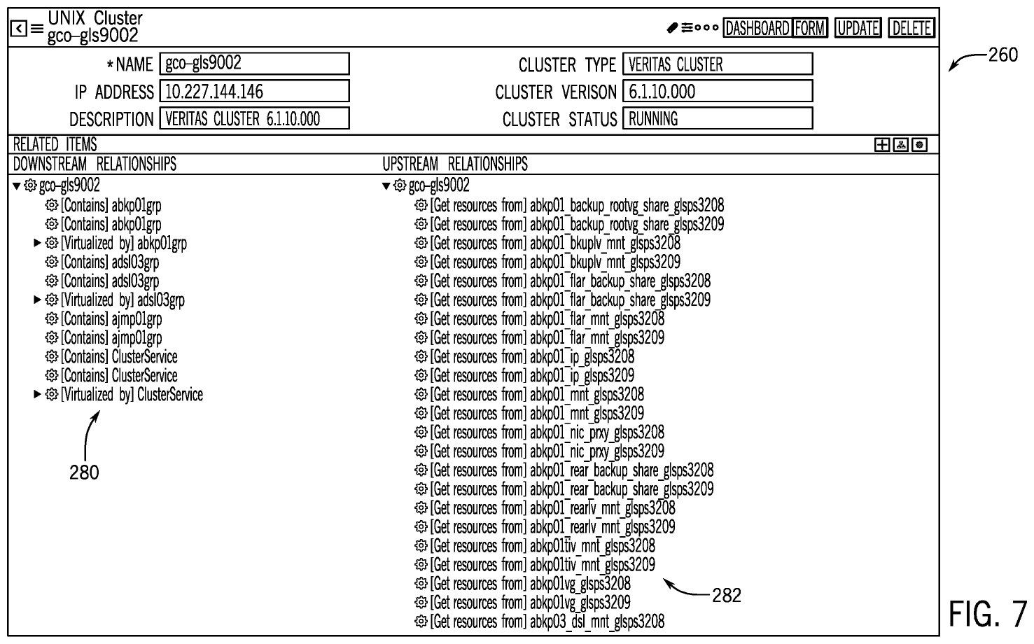

For example, FIG. 6 is a portion of the GUI 260 that is designed to present a diagram 262 that visually depicts CIs populated within the CMDB 230 for the example HA cluster, in accordance with an embodiment of the present approach. For the embodiment illustrated in FIG. 6, the diagram 262 includes a number of icons, each visually representing an aspect of the HA cluster, that are connected to one another with arrows indicating the relationship between the represented aspects. For the illustrated diagram 262, the cluster icon 264 represents the HA cluster stored in the cluster table 252A, while the node icons 266A and 266B represent nodes of the HA cluster stored in the cluster node table 252B. The resource icon 268 represents resources and/or resource groups stored in the cluster resource table 252C and/or the cluster resource group table 252D that are associated with the example HA cluster. The cluster VIP icons 270A, 270B, and 270C represent VIPs stored in the cluster VIP table 252E associated with the example HA cluster and associated with the nodes represented by the node icons 266A and 266B. Additionally, in the illustrated embodiment, the label of each icon includes a selectable element 272, illustrated as a black triangle. In response to receiving user input (e.g., a mouse click) at the selectable element, the GUI 260 may present additional information regarding that aspect of the HA cluster, such as one or more portions of the GUI 260 discussed below with respect to FIGS. 7-11.

FIG. 7 is a simulated screenshot of another portion of the GUI 260, which is designed to present information related to the example HA cluster discussed above, in accordance with an embodiment of the present approach. More specifically, the portion of the GUI 260 illustrated in FIG. 7 presents data stored in the cluster table 252A for the example HA cluster, including the cluster name, cluster status, description, and IP address. Additionally, the portion of the GUI 260 illustrated in FIG. 7 also includes a section indicating the downstream relationships 280 and upstream relationships 282 associated with the example HA cluster. In certain embodiments, the data listed for the downstream relationships 280 and upstream relationships 282 may be determined from the data stored in the cluster resource table 252C and/or cluster resource group table 252D that is associated with the example HA cluster, including other HA clusters that receive resources from (or that provide resources to) the example HA cluster during operation.

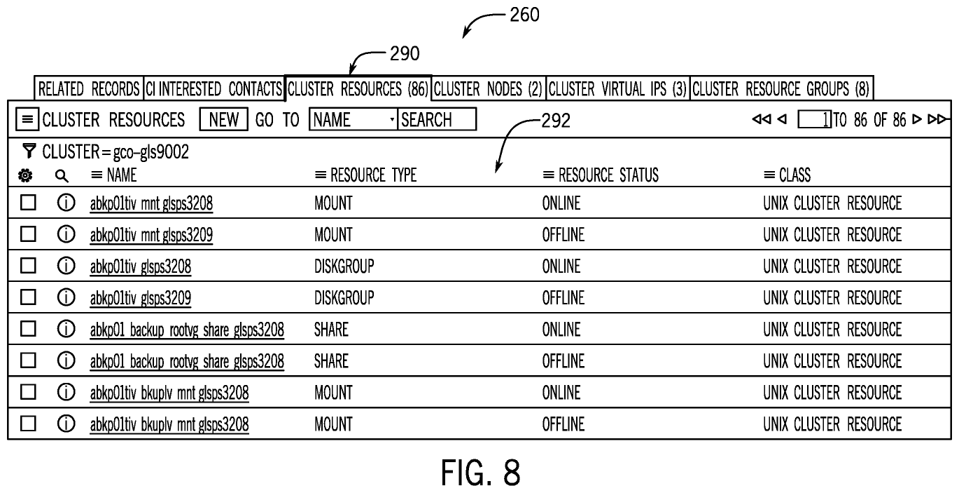

FIG. 8 is a simulated screenshot of another portion of the GUI 260, which is designed to present cluster resource information for the example HA cluster, in accordance with an embodiment of the present disclosure. It may be noted that, in certain embodiments, the portions of the GUI 260 illustrated in FIGS. 8-11 may be appended to the bottom of the portion of the GUI 260 illustrated in FIG. 7. For the portion of the GUI 260 illustrated in FIG. 8, the cluster resources tab 290 is selected, and the corresponding pane includes a table 292 listing the resource information associated with the example HA cluster that is retrieved from the cluster resource table 252C of the cluster database 250. More specifically, for the example illustrated in FIG. 8, the table 292 lists the resource name, resource type, resource status, and resource class of each resource associated with the example HA cluster.

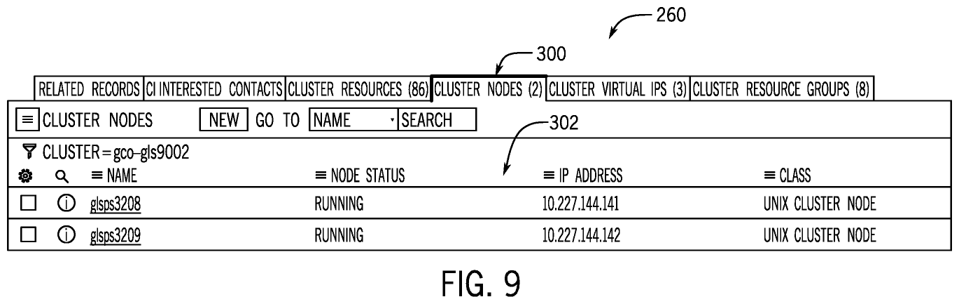

FIG. 9 is a simulated screenshot of another portion of the GUI 260, which is designed to present cluster node information for the example HA cluster, in accordance with an embodiment of the present disclosure. For the portion of the GUI 260 illustrated in FIG. 9, the cluster nodes tab 300 is selected, and the corresponding pane includes a table 302 listing the cluster node information associated with the example HA cluster that is retrieved from the cluster node table 252B of the cluster database 250. More specifically, for the example illustrated in FIG. 9, the table 302 lists the name, status, IP address, and class of each node associated with the example HA cluster.

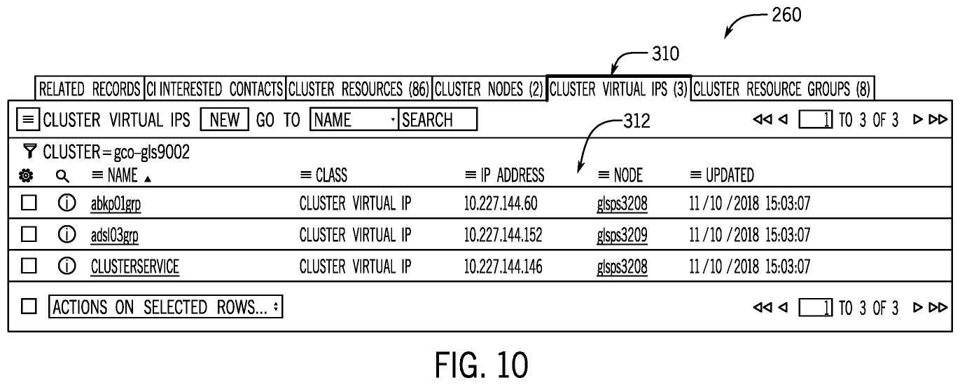

FIG. 10 is a simulated screenshot of another portion of the GUI 260, which is designed to present cluster virtual internet protocol (VIP) address information for the example HA cluster, in accordance with an embodiment of the present disclosure. For the portion of the GUI 260 illustrated in FIG. 10, the cluster virtual IPs tab 310 is selected, and the corresponding pane includes a table 312 listing the VIP information associated with the example HA cluster retrieved from the cluster VIP table 252E of the cluster database 250. More specifically, for the example illustrated in FIG. 10, the table 312 lists the name, class, virtual IP address, node name, and date last updated of each VIP address associated with the example HA cluster.

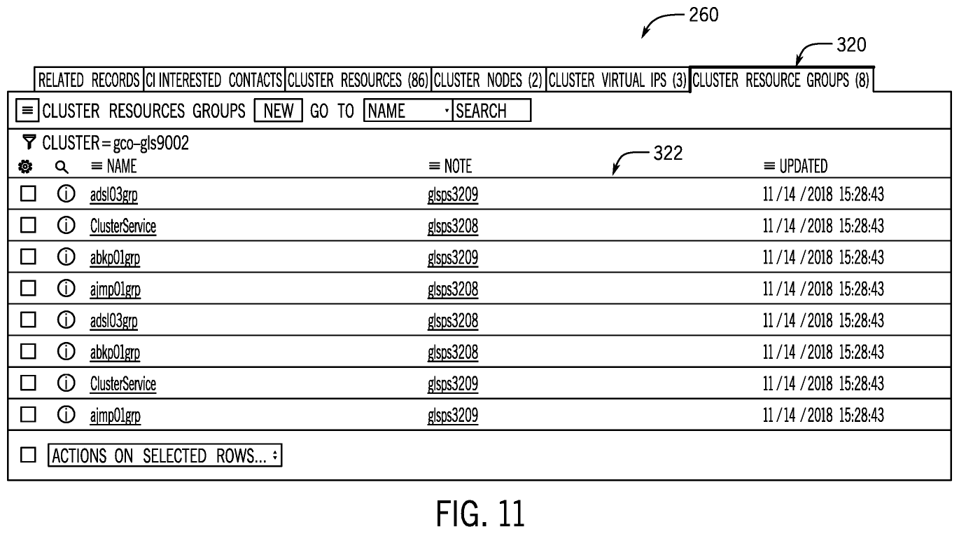

FIG. 11 is a simulated screenshot of another portion of the GUI 260 designed to present cluster resource group information for the example HA cluster, in accordance with an embodiment of the present disclosure. For the portion of the GUI 260 illustrated in FIG. 11, the cluster resource groups tab 320 is selected, and the corresponding pane includes a table 322 listing the resource group information associated with the example HA cluster that is retrieved from the cluster resource group table 252D of the cluster database 250. More specifically, for the example illustrated in FIG. 11, the table 322 lists the resource group name, status, IP address, class of the resource groups associated with the example HA cluster.

The technical effects of the present disclosure include enabling information regarding HA clusters to be determined, stored, retrieved, and presented in an effective and efficient manner. In particular, present embodiments enable cluster information to be determined and then stored and accessed as CIs within a CMDB. Additionally, present embodiments include GUI that enables cluster information to be retrieved, presented, and explored in an efficient manner.

The specific embodiments described above have been shown by way of example, and it should be understood that these embodiments may be susceptible to various modifications and alternative forms. It should be further understood that the claims are not intended to be limited to the particular forms disclosed, but rather to cover all modifications, equivalents, and alternatives falling within the spirit and scope of this disclosure.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112(f). However, for any claims containing elements designated in any other manner, it is intended that such elements are not to be interpreted under 35 U.S.C. 112(f).

1. A configuration management database (CMDB) system, comprising:
at least one processor configured to execute instructions stored in at least one memory to perform actions comprising:
retrieving cluster information regarding a high availability (HA) cluster;
storing the cluster information as configuration items (CIs) within a CMDB; and
in response to receiving a request for the cluster information, retrieving the cluster information from the CIs of the CMDB and providing the cluster information as a response to the request.

2. The CMDB system of claim 1, wherein the at least one processor is configured to execute the instructions stored in the memory to perform actions comprising:
retrieving cluster information regarding the HA cluster by performing a function call to a HA cluster server associated with the HA cluster or reading a configuration file of the HA cluster server.

3. The CMDB system of claim 1, wherein the at least one processor is configured to execute instructions to cause the display of a graphical user interface (GUI) associated with the CMDB and to execute the instructions stored in the memory to perform actions comprising:
receiving the request for the cluster information from a client device; and
presenting, via the GUI, the cluster information from the CIs of the CMDB on a display of the client device, wherein the GUI includes a diagram that visually depicts the cluster information.

4. The CMDB system of claim 1, wherein the CMDB includes a cluster table, a cluster node table, a cluster resource table, a cluster resource group table, and a cluster virtual internet protocol (VIP) address table.

5. The CMDB system of claim 4, wherein the cluster table comprises a cluster name field, a cluster status field, a cluster description field, a cluster caption field, and a cluster internet protocol (IP) address field.

6. The CMDB system of claim 4, wherein the cluster node table has a many-to-one relationship with the cluster table and comprises a node name field, a node status field, and a node state field.

7. The CMDB system of claim 4, wherein the cluster resource table has a many-to-one relationship with the cluster table, a many-to-one relationship with the cluster node table, and a many-to-one relationship with the cluster resource group table, and wherein the cluster resource table comprises a resource name field, a resource description field, a resource caption field, a resource type field, a resource status field, and a resource properties field.

8. The CMDB system of claim 4, wherein the cluster resource group table has a many-to-one relationship with the cluster table, a many-to-one relationship with the cluster node table, and a one-to-many relationship with the cluster resource table, and wherein the cluster resource group table comprises a resource group name field, a resource group cluster field, a resource group status field, a resource group type field, a resource group description field, and a resource group server field.

9. The CMDB system of claim 4, wherein the cluster VIP table has a many-to-one relationship with the cluster table and a many-to-one relationship with the cluster node table, and wherein the cluster VIP table comprises a VIP name field and a VIP address field.

10. A method of aggregating cluster information for a high-availability (HA) cluster in a configuration management database (CMDB), comprising:
retrieving the cluster information for the HA cluster from a HA server that hosts the HA cluster;
storing the cluster information as configuration items (CIs) within the CMDB; and
retrieving and providing the cluster information from the CIs of the CMDB in response to a request.

11. The method of claim 10, wherein retrieving cluster information for the HA cluster comprises retrieving cluster information regarding the HA cluster by performing a function call associated with the HA cluster server.

12. The method of claim 10, wherein retrieving cluster information for the HA cluster comprises reading a configuration file of the HA cluster server.

13. The method of claim 10, wherein storing the cluster information comprises storing the cluster information within a cluster table, a node table, a cluster resource table, a cluster resource group table, and a cluster virtual internet protocol (VIP) address table of the CMDB.

14. The method of claim 10, comprising:
receiving the request from a client device; and
presenting, via a screen of a graphical user interface (GUI) of the CMDB, the cluster information from the CIs of the CMDB, wherein the presented cluster information comprises information regarding nodes of the HA cluster, resources of the HA cluster, resource groups of the HA cluster, and VIP addresses of the HA cluster.

15. A non-transitory, computer-readable medium storing instruction executable by a processor of a computing system to aggregate cluster information for a high-availability (HA) cluster in a configuration management database (CMDB), wherein the instructions comprise instructions to:
retrieve cluster information for the HA cluster by performing function calls to, or reading configuration files of, a HA cluster server that hosts the HA cluster;
store the cluster information as configuration items (CIs) within a plurality of tables of the CMDB; and
in response to a request for the stored cluster information, retrieve the cluster information from the CIs of the CMDB and present the cluster information on a graphical user interface (GUI) associated with the CMDB.

16. The medium of claim 15, wherein the presented cluster information comprises upstream relationships and downstream resource relationships of the HA cluster.

17. The medium of claim 15, wherein the cluster information comprises cluster resource information, and wherein the cluster resource information comprises a resource type and a resource status for each resource associated with the HA cluster.

18. The medium of claim 15, wherein the cluster information comprises cluster resource group information, and wherein the cluster resource information comprises a resource group status and a resource group type for each resource group associated with the HA cluster.

19. The medium of claim 15, wherein the cluster information comprises cluster node information, and wherein the cluster node information comprises a node status and a node state for each node of the HA cluster.

20. The medium of claim 15, wherein the cluster information comprises VIP information, and wherein the cluster VIP information comprises a VIP address for one or more nodes of the HA cluster.
